(19) United States
(12) Patent Application Publication
(10) Pub. No.: US 2009/0222217 A1
(43) Pub. Date: Sep. 3, 2009

(54) Method of calculating environment risk of a chemical in soil

(75) Inventors: Daniel T. Rogers, Geneva, IL (US); Martin M. Kaufman, Commerce, MI (US); Kent S. Murray, Dearborn, MI (US)

Correspondence Address: AMSTED Industries Inc., Two Prudential Plaza, Suite 1800, 180 N. Stetson, Chicago, IL, 60601, US

(73) Assignee: AMSTED Industries Inc.

(21) Appl. No.: 12/072,802

(22) Filed: Feb. 29, 2008

(51) Int. Cl. G06F 19/00

(52) U.S. Cl. 702/22

(57) ABSTRACT

A method of calculating a soil contaminant risk factor for a chemical released into the environment is provided. The method comprises the steps of determining the toxicity value (T) of the chemical, determining the mobility (M) of the chemical in the soil where the chemical was released, determining the persistence value (P) of the chemical, and calculating the soil contaminant risk factor (SCRF) using the formula

$$S C R F = \frac{1}{( T )} * ( M ) * ( P )$$

### BACKGROUND OF THE INVENTION

The invention is an analytical method of calculating a specific chemical compounds' risk to human health and the environment in soil. The derivation by which this risk factor is calculated is through the means of multiplying the values of Toxicity (T), Mobility (M), and Persistence (P) together to form what is termed a soil contaminant risk factor (SCRF). The invention relies on the combined interactive effects of these three critical components to describe the risk posed by a particular chemical in soil if it is released into the environment.

Contaminants released into the environment only present a risk to humans if there is a completed exposure pathway. Therefore, toxicity is not the only factor that should be considered when evaluating the potential risk posed by a particular chemical compound. This is because toxicity relates only to an organisms response to a chemical after exposure and not to a chemicals' ability to migrate in the environment to a point of exposure or to the time period a chemical remains potent at a potential point of exposure in the environment before it is degraded. Therefore, other factors, such as mobility and persistence of a particular chemical should also be considered when evaluating the risk posed by that particular chemical.

Mobility is important from a transport perspective and relies on physical/chemical attributes of migration potential that include (1) solubility, (2) vapor pressure, (3) molecular weight, and (4) adsorption potential.

Persistence is important from a time perspective and refers to the length of time that a chemical remains in the environment before it is degraded either physically, chemically, or biologically.

An example demonstrating the importance of migration and persistence would be the presence of a chemical that is extremely toxic to humans but does not migrate and degrades rapidly in the environment. In this example, the toxic chemical does not have the ability to spread and potentially expose a large population than it would have otherwise had if the chemical migrated more readily. In addition, if the chemical degrades rapidly in the environment the probability of exposing a large population are further decreased. The risks may be significantly higher for a chemical that is not as toxic to humans but has a propensity to migrate to a point of exposure where potentially large populations are exposed.

Accordingly, it is the objective of the present invention to provide an analytical method that can be used to calculate a contaminant risk factor that integrates each of the critical attributes of toxicity, mobility, and persistence into a mathematical equation that will precisely describe a specific chemicals' risk to humans and the environment in soil.

### SUMMARY OF THE INVENTION

An analytical method was developed that is used to calculate a specific chemical compounds' risk to human health and the environment in soil. The analytical method used to derive what is termed a “soil contaminant risk factor” (SCRF) is a combined function of three criteria that include (1) toxicity, (2) mobility, and (3) persistence.

The formula to calculate the SCRF for any chemical is as follows:

$$S C R F = \frac{1}{( T )} * ( M ) * ( P )$$

where: SCRF=Soil Contaminant Risk Factor; T=toxicity; M=mobility; P=persistence

### BRIEF DESCRIPTION OF THE DRAWING

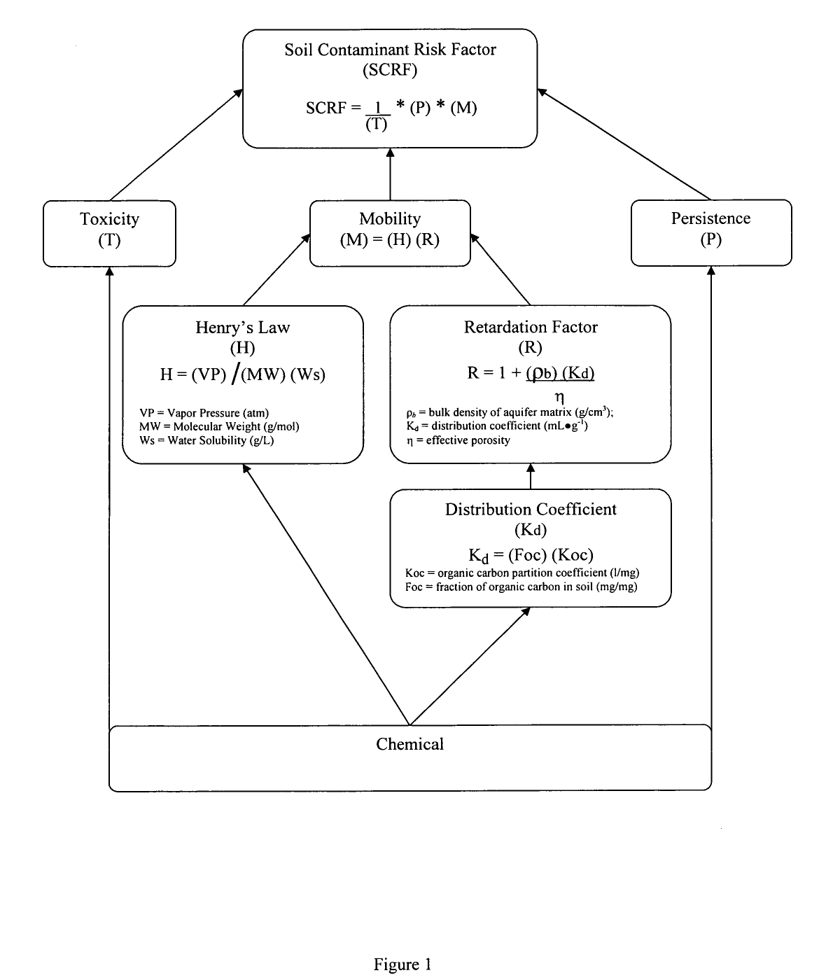

In the drawing, FIG. 1 is a flow chart of the steps in accordance with the embodiment of the present invention.

### DETAILED DESCRIPTION OF INVENTION

An analytical method was developed to calculate a specific chemical compounds' risk to human health and the environment in soil.

The analytical method used to derive what is termed a “soil contaminant risk factor” (SCRF) to soil is a combined function of three criteria:

1) toxicity,

2) mobility, and

3) persistence.

The formula to calculate the CRF for any chemical in groundwater is as follows:

$$S C R F = \frac{1}{( T )} * ( M ) * ( P )$$

where: SCRF=Soil Contaminant Risk Factor; T=toxicity; M=mobility; P=persistence

Contaminants or chemical compounds that are released into the environment only present a risk to humans if there is a completed exposure pathway. Therefore, toxicity is not the only factor that should be considered when evaluating the risk posed by the presence of a particular chemical compound. In many cases, a chemical that is extremely toxic to humans may not present as much risk as a chemical that is only moderately toxic but is mobile and has a high propensity to migrate and does not rapidly degrade. Therefore, a more precise explanation of environmental risk posed by a specific compound is a combined function of the three criteria listed above.

### Derivation of a CRF for any Chemical Compound can be Conducted by Following the Steps Outlined Below:

### 1.0 Toxicity Value:

Toxicity is defined as the deleterious or adverse biological response or effect to exposure to a physical, chemical, or biological agent. Toxicity values are readily obtained from the USEPA Integrated Risk Information System (IRIS). Toxicity values selected were the more conservative value listed for either carcinogenic or chronic effects. The more conservative of either the oral dermal pathway was selected because oral ingestion or dermal contact with soil is expected to be the dominant exposure pathway.

### 2.0 Mobility Value:

Mobility it defined as the ability of a chemical to migrate in the environment. Mobility of a chemical in the environment is governed by two factors that include the physical chemistry of the chemical and the physical and chemical characteristics of the geologic environment to which the chemical is released.

To obtain a value to represent the mobility of each compound, two variables are used: Henry's Law constant (H), which focuses on the physical chemistry of the chemical and the retardation factor (R), which focuses on the physical and chemical characteristics of the geological environment. The retardation factor was calculated by first calculating the distribution coefficient using Equation 1.

K_{d}=(Foc)(Koc) [1]

where: K_{d}=distribution coefficient (mL·g⁻¹); Koc=organic carbon partition coefficient (l/mg); Foc=fraction of organic carbon in soil (mg/mg)

Values for the organic carbon partition coefficient can be obtained from location-specific testing of soil or from various published sources. And the fraction of organic carbon in soil can be obtained from location-specific testing of soil or from various published sources.

Once the distribution coefficient is calculated, the Retardation Factor can be calculated using Equation 2.

$$R = 1 + \frac{( {ρ}_{b} ) ( {K}_{d} )}{η} \qquad [ 2 ]$$

where: R is the retardation factor; ρ_{b}=bulk density of aquifer matrix (g/cm³); K_{d}=distribution coefficient (mL·g⁻¹); η=effective porosity

Henry's Law constant (H) (atm.·mol⁻¹·m⁻³) is a measure of the tendency for organic solutes to volatilize. It is related to vapor pressure (VP) (atm.), molecular weight (MW) (g/mol); and solubility in water (Ws) (g/L) according to Equation (3):

H=(VP)/(MW)(Ws) [3]

With Henry's Law constant and the retardation factor in place, the mobility of a specific compound is expressed as Equation (4):

M=(H)(R) [4]

where: M=mobility; H=Henry's Law constant; R=retardation factor

### 3.0 Persistence Value:

Persistence refers to a chemical's stability in the environment and is defined as the length of time a chemical remains in the environment before it is degraded by either physical, chemical, or biological processes.

Persistence values can be obtained from various published sources and are generally expressed as first order decay rates in years. In general, the first order decay rates selected for each compound are chosen as the most conservative of the spectrum of data available.

### 4.0 Contaminant Risk Factor for Soil:

Finally, the Soil Contaminant Risk Factor (SCRF) can be calculated by multiplying the inverse of the chemical compound's Toxicity by its Mobility by its Persistence (P) in the environment. Using the inverse of the chemical compound's toxicity ensures that the toxicity value remains a positive integer so that appropriate weighting of the values can be achieved. The SCRF equation is expressed as Equation (5):

$$S C R F = \frac{1}{( T )} * ( M ) * ( P ) \qquad [ 5 ]$$

where: SCRF=Soil Contaminant Risk Factor; T=toxicity; M=mobility; P=persistence (years)

### 5.0 Example Calculation

An example calculation for the chemical benzene is as follows:
Step 1: Calculating the toxicity value (T) (mg/kg-days⁻¹)
   The toxicity value (T) (mg/kg-day⁻¹) for benzene is 0.04 and was obtained from published sources.

Therefore,

T=0.04 mg/kg-day⁻¹
Step 2: Calculating the distribution coefficient (K_{d}) (mL·g⁻¹)

K_{d}=(Foc)(Koc)
Koc for benzene is 58.9 l/mg and is obtained from published sources
Foc for sand is 0.0003 mg/mg and is either obtained as an estimate value from published sources or is obtained from conducting location-specific testing of soil.
Therefore,

K_{d}=Foc×Koc

K_{d}=0.0003×58.9

K_{d}=0.0177
Step 3: Calculating the retardation factor (R)

$$R = 1 + \frac{( {ρ}_{b} ) ( {K}_{d} )}{η}$$

ρ_{b}=is the bulk density of the aquifer matrix (g/cm³) and for sand is 1.8 g/cm³ and is either obtained as an estimated value from published sources or is obtained from conducting location-specific testing of soil.
K_{d}=is the distribution coefficient which was calculated in step 2 and the value is 0.0177 mL·g⁻¹
η=the effective porosity and is 0.25, which can be measured directly or estimated for sand using values from published sources
Therefore,

$$R = 1 + \frac{( {ρ}_{b} ) ( {K}_{d} )}{η}$$

$$R = 1 + \frac{( 1.8 ) ( 0.0177 )}{0.25}$$

R=1.13
Step 4: Calculating Henry's Law constant (H) (atm.·mol⁻¹·m⁻³)
   Henry's Law Constant for benzene is 0.228 atm.·mol⁻¹·m⁻³ and was obtained from published sources
   Therefore,

H=0.228
Step 5: Calculating the mobility factor (M)

M=(H)(R)

H=0.228 from Step 4

R=1.13 from Step 3
Therefore,

M=(0.228)(1.13)

M=0.2576
Step 6: Calculating the persistence value (P) (years)
   The persistence value (P) (years) for benzene is 0.2 (years) and was obtained from published sources.
   Therefore,

P=0.2 years
Step 7: Calculating the Soil Contaminant Risk Factor (SCRF) for benzene in sand is expressed as follows:

$$S C R F ( benzene in sand ) = \frac{1}{( T )} * ( M ) * ( P )$$

Where:

T=0.04

M=0.2576

P=0.2
Therefore,

$$S C R F = \frac{1}{0.04} * 0.2576 * 0.2$$

CRF=1.288

What is claimed is:

1. A method for calculating a contaminant risk factor for a chemical released into soil,
the method comprising the steps of:
determining the toxicity value (T) of the chemical, determining the mobility value (M) of the chemical in the soil where the chemical was released,
determining the persistence value (P) of the chemical, and
calculating the soil contaminant risk factor (SCRF) for the chemical using the formula
$$S C R F = \frac{1}{( T )} * ( M ) * ( P )$$

2. The method of claim 1
wherein the toxicity value (T) for the chemical is obtained from the United States Environmental Protection Agency (USEPA) Integrated Risk Information System (IRIS).

3. The method of claim 1
wherein the mobility value (M) for the chemical in the soil of concern is determined by:
calculating a Henry's law constant (H) and a retardation factor (R), and calculating the mobility value (M) using the formula
M=(H)(R).

4. The method of claim 3
wherein the Henry's law constant (H) is calculated by:
determining the vapor pressure (VP) of the chemical, determining the molecular weight (MW) of the chemical, and determining the solubility of the chemical in water (Ws), and calculating the Henry's law constant (H) for the chemical using the formula:
H=(VP)/(MW)(Ws)

5. The method of claim 3
wherein the retardation factor (R) is calculated by determining a distribution coefficient (K_{d}),
the distribution coefficient (K_{d}) is calculated by determining the fraction of organic carbon (Foc) in the soil, determining the organic carbon partition coefficient (Koc) for the chemical, and calculating the distribution coefficient (K_{d}) by using the formula:
K_{d}=(Foc)(Koc),
determining the bulk density of the aquifer matrix (ρ_{b}) for the soil,
determining the effective porosity (η) for the soil,
and calculating the retardation factor (R) using the formula:
$$R = 1 + \frac{( {ρ}_{b} ) ( {K}_{d} )}{η}$$

6. The method of claim 5
wherein the fraction of organic carbon (Foc) in the soil is determined by analyzing a sample of the soil or by using an estimated value from various published sources.

7. The method of claim 5
wherein the fraction of organic carbon (Foc) in the soil is obtained from published values for soils in the area of the chemical release.

8. The method of claim 5
wherein the bulk density of the aquifer matrix (ρ_{b}) is of the soil determined by analyzing a sample of the soil or is obtained from published values.

9. The method of claim 5
wherein the effective porosity (η) of the soil is determined by analyzing a sample of the soil or is obtained from published values.

10. A method for calculating a contaminant risk factor for a chemical in a soil, the method comprising the steps of:
determining the toxicity value (T) of the chemical,
determining the mobility (M) of the chemical in the soil,
determining the persistence (P) of the chemical,
and calculating the contaminant risk factor (CRF) for the chemical using the formula:
$$S C R F = \frac{1}{( T )} * ( M ) * ( P )$$

11. The method of claim 10
wherein the toxicity value (T) of the chemical is obtained from the United States Environmental Protection Agency (USEPA) Integrated Risk Information System (IRIS).

12. The method of claim 10
wherein the mobility value (M) for the chemical in the soil is determined by:
calculating a Henry's law constant (H) and retardation factor (R), and calculating the mobility value (M) using the formula:
M=(H)(R).

13. The method of claim 12
wherein the Henry's law constant (H) is calculated by:
determining the vapor pressure (VP) of the chemical, determining the molecular weight (MW) of the chemical, and determining the solubility of the chemical in water (Ws), and calculating the Henry's law constant (H) for the chemical using the formula:
H=(VP)/(MW)(Ws)

14. The method of claim 12
wherein the retardation factor (R) is calculated by determining a distribution coefficient (K_{d}),
the distribution coefficient (K_{d}) is calculated by determining the fraction of organic carbon (Foc) in the soil, determining the organic carbon partition coefficient (Koc) for the chemical,
and calculating the distribution coefficient (K_{d}) using the formula:
K_{d}=(Foc)(Koc)
determining the bulk density (ρ_{b}) for the soil, determining the effective porosity (η) for the soil, and calculating the retardation factor (R) using the formula
$$R = 1 + \frac{( {ρ}_{b} ) ( {K}_{d} )}{η}$$

15. The method of claim 14
wherein the fraction of organic carbon (Foc) in the soil is determined by analyzing a sample of the soil or is obtained from published values.

16. The method of claim 14
wherein the fraction of organic carbon (Foc) in the soil is obtained from published values of soils.

17. The method of claim 14
wherein the bulk density of the aquifer matrix (ρ_{b}) of the soil is determined by analyzing a sample of the soil or is obtained from published values.

18. The method of claim 14
wherein the effective porosity (η) of the soil is determined by analyzing a sample of the soil or is obtained from published values.
